(19) United States
(12) Patent Application Publication
(10) Pub. No.: US 2009/0301589 A1
(43) Pub. Date: Dec. 10, 2009

(54) DIRECT ACTING ZERO LEAK 4/3 TANDEM CENTER NEUTRAL VALVE

(76) Inventor: Roger R. Pili, Madison, WI (US)

Correspondence Address: QUARLES & BRADY LLP, 411 E. WISCONSIN AVENUE, SUITE 2040, MILWAUKEE, WI, 53202-4497, US

(21) Appl. No.: 11/721,008

(22) PCT Filed: Dec. 14, 2005
(86) PCT No.: PCT/US05/45035

§ 371 Date: Jun. 6, 2007

Related U.S. Application Data
(60) Provisional application No. 60/636,150, filed on Dec. 15, 2004.

(51) Int. Cl. F16K 11/00; F16K 31/02

(52) U.S. Cl. 137/625.66; 251/129.15; 137/625.25

(57) ABSTRACT

A 4-way 3-position direct acting tandem center neutral valve has two 3-way, 2-position poppet valves configured so as to provide 4-way, 3-position tandem center neutral valve functions so that it is direct acting and essentially zero leak.

### CROSS-REFERENCE TO RELATED APPLICATION

This claims the benefit of U.S. Provisional Patent Application No. 60/636,150 filed Dec. 15, 2004.

### STATEMENT CONCERNING FEDERALLY SPONSORED RESEARCH OR DEVELOPMENT

Not applicable.

### FIELD OF THE INVENTION

This invention relates to hydraulic control valves, and in particular to 4-way 3-position valves.

### BACKGROUND OF THE INVENTION

In a tandem center neutral hydraulic control valve, the load, for example, a double-acting hydraulic cylinder, is held in a particular position if the power is off to the valve. In other words, the load is held in the position it was in when the valve was turned off.

Prior tandem center neutral hydraulic control valves have typically been 4-way, 3-position solenoid operated spool valves. Spool valves inherently have clearances that result in leakage, which is undesirable in a tandem center neutral valve, since the whole idea is to hold the load at a particular position. In other prior tandem center neutral valves, a master/slave arrangement was used in which the master was a spool valve that produced a pilot pressure to control a slave valve that may have been a poppet valve, to hold the poppet valve closed or to open it. Such valves have leakage in the spool sections and also are not, in the case of the master/slave valve, direct acting since the solenoid that controls the master valve is to produce a pilot pressure, that in turn controls the slave valve. Therefore, a need exists for a direct acting, zero leak 4-way 3-position (4/3) tandem center neutral hydraulic control valve.

### SUMMARY OF THE INVENTION

The invention provides an improved 4-way 3-position tandem center neutral direct acting valve by providing a pair of 3-way 2-position poppet valves in a system that achieves the objectives of a 4-way 3-position tandem center neutral valve.

In particular, the two solenoid-operated poppet valves are incorporated in a circuit such that one of them has its center port connected to a source of pressure, with the center port of the other poppet valve connected to tank. The normally open-to-center ports of both poppet valves are connected to one another and are connected to the load by a pressure operated normally biased closed one-way valve that in the absence of its pilot override pressure does not permit flow back to the normally open ports of the poppet valves from the load.

The normally closed ports of the poppet valves may also be connected to the load by a pressure operated normally biased closed one-way valve that in the absence of its pilot override pressure does not permit flow back to the normally open ports of the poppet valves from the load. For example, if the load is a double acting hydraulic cylinder, these ports can be connected to the bore side of the cylinder and the other ports can be connected to the rod side, downstream from the one-way valve. The pilot pressure for operating the one-way valve is dependent on the pressure at the normally-closed ports of the poppet valves. The pilot pressure for the other one-way valve, if provided, is dependent on the pressure at the normally open ports of the poppet valves.

In this configuration, actuating the second poppet valve connects the source of pressure to the normally-closed port, which also provides the override pressure to open the one-way valve to permit reverse flow from the load to the normally-open port of the first poppet valve that is connected via the center port of that poppet valve to tank. When the second poppet valve is actuated, the normally-open port of that valve is blocked. When a sufficient volume of fluid or pressure has been supplied to the load by actuation of the second poppet valve, that poppet valve can be de-energized. This holds the pressure delivered to the load by the second poppet valve, and directs the source of pressure to tank via the normally-open port of the second valve that is connected to tank via the center port of the first valve. The pressure of the load maintains the one-way valve open to flow in the normally-closed direction of the one-way valve.

When the first poppet valve is energized, while maintaining the second poppet valve de-energized, the normally-closed port of the second poppet valve is opened to tank via the center port of the first valve. In addition, the normally-open port of the first valve is blocked, which blocks the flow of fluid from the pressure source. This has the effect of delivering the fluid from the pressure source flowing through the second valve to the load, through the one-way valve. The pilot pressure on the one-way valve coming from the normally-closed port of the second poppet valve is relieved in this state of energization of the first poppet valve. The pilot pressure on the other one-way valve, if provided, coming from the normally-open ports of the first and second poppet valves will hold the other one-way valve in the open position to allow flow from the bore side of the cylinder to tank. If the first poppet valve is deenergized, the first one way check valve will hold the load until the pilot override pressure is once again supplied to the first one way check valve, for example by energizing the second poppet valve. If the second poppet valve were to also be energized while energizing the first poppet valve, flow from the pump source is directed to tank and flow from the rod side of the load would be blocked by the first one way check valve and also by both poppet valves, and flow from the bore side of the load would be blocked by the second check valve, if provided.

This provides a zero-leak direct acting valve that can be used as a 4-way 3-position tandem center neutral valve, which is solenoid operated.

Other objects and advantages of the invention will be apparent from the detailed description and drawings.

### BRIEF DESCRIPTION OF THE DRAWINGS

FIG. 1 is a front plan view of a valve of the invention;

FIG. 2 is a top plan view of the valve of FIG. 1;

FIG. 3 a side plan view of the valve;

FIG. 4 is a cross-sectional view from the plane of the line 4-4 of FIG. 1;

FIG. 5 is a cross-sectional view from the plane of the line 5-5 of FIG. 1;

FIG. 6 is a cross-sectional view from the plane of the line 6-6 of FIG. 1;

FIG. 7 is cross-sectional view from the plane of the line 7-7 of FIG. 2;

FIG. 8 is a cross-sectional view from the plane of the line 8-8 of FIG. 3;

FIG. 9 is a cross-sectional view from the plane of the line 9-9 of FIG. 3; and

FIG. 10 is a schematic circuit diagram of the valve of FIGS. 1-9, incorporated into an electrohydraulic system.

### DETAILED DESCRIPTION OF THE PREFERRED EMBODIMENT

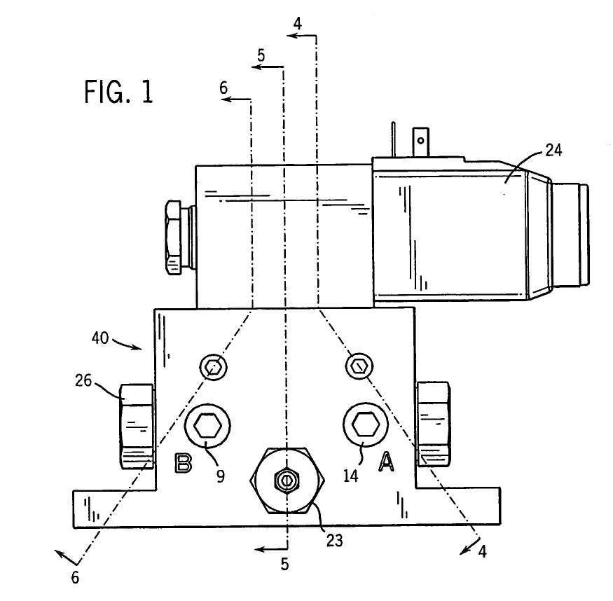

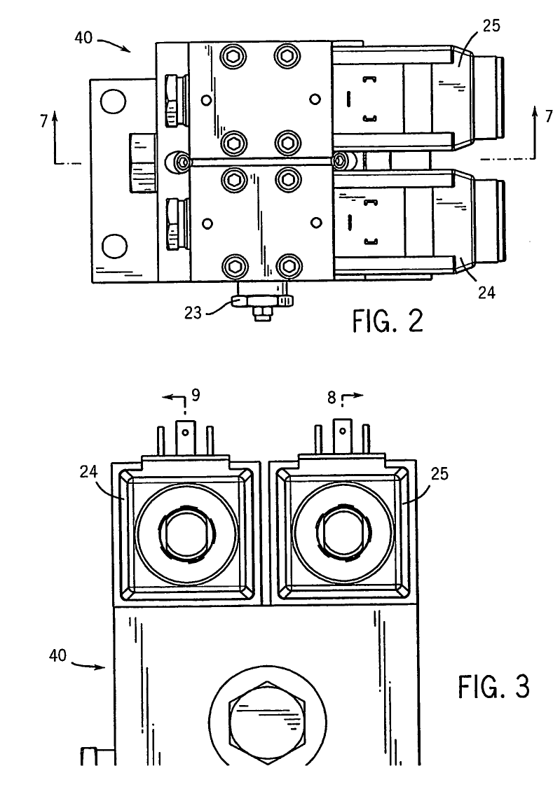

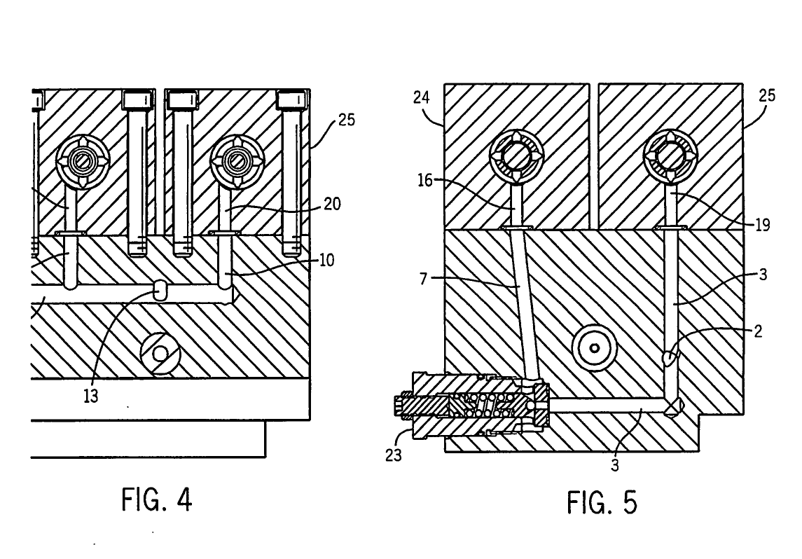

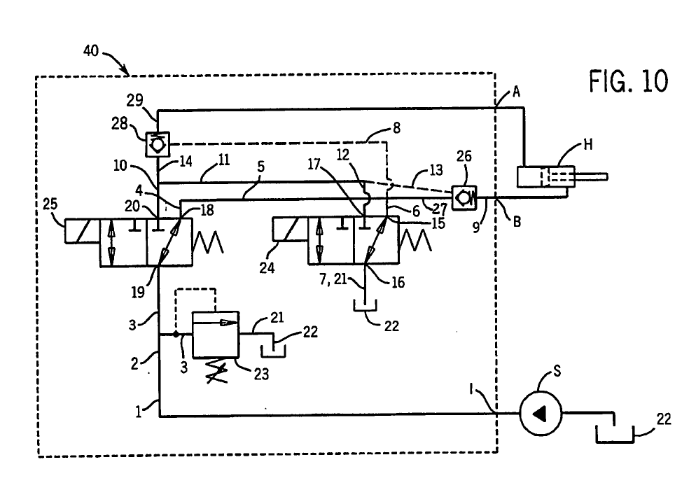

FIGS. 1-9 illustrate a valve 40 of the invention and FIG. 10 is a hydraulic circuit of the valve 40 integrated into a hydraulic system. The numbers used in FIG. 10 to identify passages and components correspond to the numbers used throughout FIGS. 1-9 to identify the corresponding passages and components.

Referring particularly to FIGS. 1-9, the valve 40 includes two identical 3-way 2-position solenoid-operated spring return poppet valves 24 and 25. The poppet valves 24 and 25 may be of any suitable construction, with the construction described in U.S. Pat. No. 5,111,840 being one possibility and the valve disclosed herein. The description of the construction and operation (col. 3, line 10-col. 5, line 62) of the poppet valve disclosed in U.S. Pat. No. 5,111,840 is hereby incorporated by reference as if fully set forth herein. As is well known, a poppet valve differs from a spool valve in that in a poppet valve a surface of the poppet valve element seats axially against a valve seat, whereas in a spool valve, the valve spool is axially slidable in a valve bore to create a radial seat, which requires there to be a clearance, however small, between the outside diameter of the valve spool and the inside diameter of the valve bore, which inevitably results in some amount of leakage. A poppet valve, having an axially abutting surface against a valve seat, has zero leakage, and therefore is preferred in some applications over a spool valve, for example where load holding is desired.

Each valve 24 and 25 is solenoid-operated and is spring return. As is well known with 3-way 2-position poppet valves, a common port is in the middle of the valve with a normally-open port on one side and a normally-closed port on the other side of the center port. When the solenoid of the valve is de-energized, the spring moves the poppet valve sealing element against the seat that is adjacent to the normally-closed port, which closes that port in the de-energized position and opens the normally-open port in the de-energized position of the valve. When the solenoid is energized, the poppet valve sealing element is urged by the solenoid against the operation of the spring to seat against the seat that is adjacent to the normally-open port of the solenoid valve, which closes that port and opens the normally-closed port of the solenoid valve. With reference to FIG. 10, the center port of valve 24 is identified by reference number 16, the normally-open port is identified by reference number 6, and the normally-closed port is identified by reference number 17. For valve 25, the center port is reference number 19, the normally open port is reference number 4 and the normally-closed port is reference number 20. Valves 24 and 25 are illustrated in their normal positions in FIG. 10.

The pressure supply line is passageway 1 throughout the drawings and this is shown in FIG. 10 as being supplied by a pump or other source S of pressurized hydraulic fluid, which draws its fluid from tank or reservoir 22 that is or near atmospheric pressure. Reference number 22 also denominates the ports and passageways that are connected to the reservoir or tank, for example port 22 in FIG. 7 which is connected to the tank. In addition, tank 22, represented by port 22, is connected to the center port 16 of valve 24 via passageway 7 (FIG. 9) and 21 (FIG. 10) and these passages are connected to port 22, which is connected to the tank or reservoir source of fluid at or near atmospheric pressure.

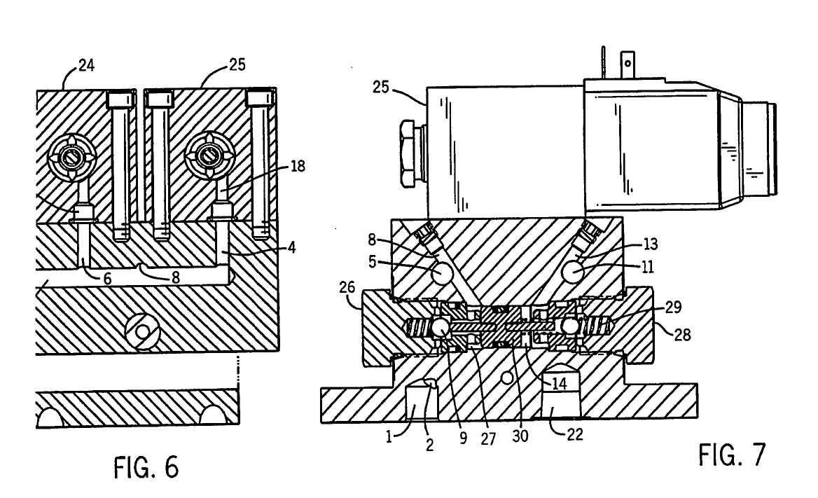

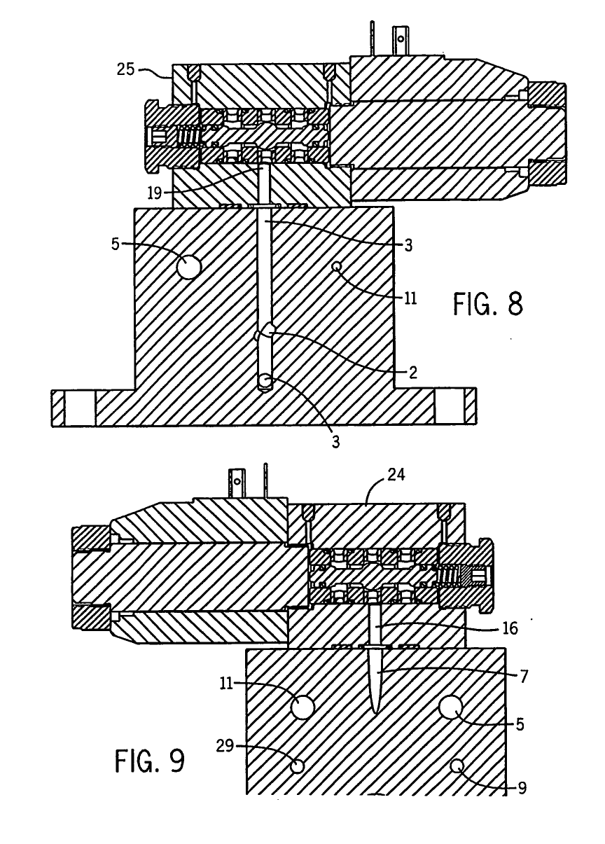

Port 1 which receives pressurized fluid from the pump S communicates with passageway 2 as illustrated in FIG. 7 and FIG. 10 and passageway 2 communicates with passageway 3 as illustrated in FIG. 8. Passageway 3 is in direct communication with center port 19 of valve 25 as illustrated in FIGS. 8 and 10. Normally-open port 18 of valve 25 communicates with passageway 5 through passageway 4 as illustrated in FIG. 6 and is in communication with passageway 6 as illustrated in FIGS. 6 and 10. Passageway 6 is in direct communication with normally-open port 15 of valve 24 and passageway 5 communicates with pressure operated normally biased closed one-way check valve 26 as illustrated in FIG. 7. Flow from passageway 5 toward check valve 26 can flow through the check valve 26 to passageway 9 without a significant restriction, but cannot flow in the reverse direction unless a pilot pressure is applied to valve 26 via passageway 13. A pressure at port 18 also lifts the ball of the one-way check valve 28 off its seat, with the pressure from port 18 being communicated to piston chamber 27 (FIG. 7) of valve 28 via passages 4, 5 and 8, to permit flow in the direction from port A to the normally closed port 20 of valve 25. Pressurizing passageway 27 moves piston 30 that pushes a pin to lift the ball of the check valve 28 off of its seat, so as to permit flow from passageway 29 to passageways 14, 11 and 12 if valve 24 is energized. If there is no significant pressure at port 18 of valve 25, then one way check valve 28 is closed to flow in the direction from port A to line 14 by its spring and any pressure on it from port A. Although a pressure at port 18 will open valve 28 to flow in the normally closed direction, that flow is from port A and no significant flow or leakage is permitted from port B.

Passageway 9 is connected to port B (FIG. 1 and FIG. 10) which as illustrated in FIG. 10 can be connected to a load. As illustrated, this load may be the rod side of a hydraulic actuator H. Port A of the valve 40 is connected to another load, which as illustrated in FIG. 10 may be the bore side of the hydraulic actuator H. The two loads connected to the ports A and B may be independent of one another, but as illustrated in FIG. 10 they are opposite sides of the piston of the same hydraulic actuator. A pressure at port 20 of valve 25 also lifts the ball of one-way check valve 26 off its seat, with the pressure from port 20 being communicated to piston chamber 14 (FIG. 7) of valve 26 via passages 10, 11 and 13, to permit flow in the direction from port B to the normally open port 15 of valve 24. Pressurizing piston chamber 14 moves piston 30 that pushes a pin to lift the ball of the check valve 26 off of its seat, so as to permit flow from the opposite side of the ball through passageway 9 to passageways 5 and 6. If there is no significant pressure at port 20 of valve 25, then one way check valve 26 is closed to flow in the direction from port B to line 5 by its spring and any pressure on it from port B. While a particular valve for the one way valves 26 and 28 has been illustrated, any type of one way valve that is opened by a pilot pressure to flow in the normally closed direction could be substituted for these valves. Although a pressure at port 20 will open valve 26 to flow in the normally closed direction, that flow is from port B and no significant flow or leakage is permitted from port A.

Thus, the valve 40 operates as follows. With both valves 24 and 25 de-energized, pressure from the source S will be directed by valve 25 through port 18 of valve 25 to the normally open port 15 of valve 24 which is connected to tank 22. Flow and pressure from the bore side of the cylinder H (port A) will be directed to the normally biased closed one-way valve 28 and therefore will be blocked. Thus, with both valves de-energized, the position of the actuator H is held constant against further retraction.

If it is desired to further extend the actuator H, valve 25 is energized which places port 20 and port A in communication with the source of pressure S to provide a flow of fluid under pressure to the bore side of the actuator H. The pressure at port 20 holds the one-way check valve 26 open, which permits flow from the rod side of the actuator H to flow to normally open port 15 of valve 24 and from there to tank 22. Thus, the piston of actuator H extends. When the new position desired of the actuator H is reached, valve 25 can be de-energized to hold that position.

When it is desired to retract the actuator H, valve 24 is energized and valve 25 is not energized which places the bore side of actuator H, via port A, in communication with the tank 22. Flow from the bore side is blocked from flowing to tank 22 by the one-way check valve 28. Similarly, with valve 24 energized and valve 25 de-energized, fluid from the source flows through one-way check valve 26 to port B, in the normally open direction through valve 26, and therefore to the rod side of actuator H. Port 15 of valve 24 is blocked when valve 24 is actuated so pressure from the source cannot flow to tank through valve 24. As pressure builds in passageway 5, due to valve 28 blocking flow in the normally closed position, the ball on the one-way valve 28 is lifted off of its seat. Thus fluid from the bore side can flow directly to tank through the valve 24. When the retraction position desired is reached, valve 24 is de-energized which will permit the pressure at port A and B to equalize and when equalized the valve 26 shuts off against flow in the direction from port B to tank through the valve 26 (a light spring biasing the valve 26 closed is illustrated in FIG. 10 and may be provided to aid in closing the valve in a near equalized pressure state across the valve, which holds the cylinder H in position, and valve 28 shuts off against flow in the direction from port A to tank through the valve 28 (a light spring biasing the valve 28 aids in closing the valve in a near equalized pressure state across the valve). As such, with a load being held against further extension of the actuator H, there will be no pressure at port A to open valve 26, and therefore flow from port B will be blocked by valve 26. Similarly, there will be no pressure at port 15 to open valve 28 and therefore flow from port A will be blocked by valve 28. Thus, when both valves 24 and 25 are de-energized, the actuator H is held in position both from extending further or retracting further, with essentially zero leakage, so as to hold its position every time and with direct acting valves which do not require pilot pressures for operation.

The valve 40 may also include an adjustable pressure relief valve 23 of any suitable configuration, as illustrated in FIGS. 5 and 10. The purpose of the pressure relief valve 23 is to relieve any excess pressures that occur in the lines between the valve 25 and the source of pressure S. Pressure relief valve 23 is connected to passageway 2 at its inlet and by passageway 21 to tank 22.

Many modifications and variations to the preferred embodiment described will be apparent to those skilled in the art. Therefore, the invention should not be limited to the embodiment described, but should be defined by the claims which follow.

I claim:

1. A 4-way, 3-position hydraulic valve, comprising a pair of 3-way, 2-position solenoid actuated poppet valves wherein one of the valves has a center port in communication with a source of hydraulic pressure, the other poppet valve has a center port in communication with a tank pressure, normally open ports of both poppet valves are in communication with a first load port of the 4-way, 3-position hydraulic valve through a one-way check valve that normally permits flow in the direction toward the first load port and normally blocks flow in the reverse direction away from the first load port and wherein the normally closed ports of both poppet valves are in communication with a second load port of the valve and are also in communication with a pressure override port of the one-way check valve so that when the pressure at the normally closed ports is sufficient, the one-way check valve is opened to flow through it from the first load port.

2. A 4-way, 3-position valve as claimed in claim 1, wherein the load ports are connected to opposite ends of a hydraulic actuator.

3. A 4-way, 3-position valve as claimed in claim 1, wherein the one-way check valve is a ball type check valve.

4. A 4-way, 3-position valve as claimed in claim 1, wherein the one-way check valve is opened to flow through it from the first load port when the pressure at the normally closed ports of the poppet valves is sufficient to open the one-way check valve.

5. A 4-way, 3-position valve as claimed in claim 1, wherein the one-way check valve is spring biased to a closed position.

6. A 4-way, 3-position valve as claimed in claim 1, wherein the normally open ports of the poppet valves are also in communication with a pressure override port of a second one-way check valve that normally blocks flow from the second load port to the normally closed ports of the poppet valves so that when the pressure at the normally open ports is sufficient, the second one-way check valve is opened to flow through it from the second load port.
